(19) United States
(12) Patent Application Publication
(10) Pub. No.: US 2018/0069327 A1
(43) Pub. Date: Mar. 8, 2018

(54) TERMINAL-EQUIPPED ELECTRIC WIRE

(71) Applicant: Yazaki Corporation, Tokyo (JP)

(72) Inventors: Hirohito NAKATA, Makinohara-shi (JP); Masaru FUKUDA, Makinohara-shi (JP); Kazuhide TAKAHASHI, Makinohara-shi (JP)

(73) Assignee: Yazaki Corporation, Tokyo (JP)

(21) Appl. No.: 15/692,489

(22) Filed: Aug. 31, 2017

(30) Foreign Application Priority Data
Sep. 2, 2016 (JP) 2016-172014

(51) Int. Cl. H01R 4/18; H01R 4/70; H01R 4/62; H01R 13/03; H01R 43/16; H01R 43/048; H01R 13/533

(52) U.S. Cl. CPC H01R 4/18; H01R 4/70; H01R 4/62; H01R 4/58; H01R 43/16; H01R 43/048; H01R 13/533; H01R 13/03

(57) ABSTRACT

A terminal-equipped electric wire includes an electric wire in which a core wire made of aluminum or an aluminum alloy is covered with a covering, and a terminal fitting made of copper or a copper alloy and crimped to an end portion of the electric wire in which the core wire is exposed. The terminal fitting includes a pair of crimp pieces. End portions of the pair of the crimped portions are crimped in a state where the end portions of the pair of the crimped portions are overlapped with each other, so as to cover a surrounding of the electric wire from a leading end of the core wire to a part of the covering. At least the pair of the crimp pieces have top surfaces, bottom surfaces and side surfaces covered with anti-corrosive plated layers.

### CROSS REFERENCE TO RELATED APPLICATIONS

This application claims priority from Japanese Patent Application No. 2016-172014 filed on Sep. 2, 2016, the entire contents of which are incorporated herein by reference.

### BACKGROUND OF THE INVENTION

### Field of the Invention

The present invention relates to a terminal-equipped electric wire to an end portion of which a terminal fitting is connected.

### Description of Related Art

For example, as a wire harness routed in a vehicle, a terminal-equipped electric wire where a terminal fitting made of copper or a copper alloy is crimped to an electric wire having a core wire made of aluminum or an aluminum alloy is used for weight reduction. In this terminal-equipped electric wire, there is a possibility that adhering water becomes an electrolyte between the core wire and the terminal fitting, which are different metals, of the electric wire to cause galvanic corrosion.

For this reason, it is performed to inhibit corrosion by forming a plated layer or an insulating layer on the surface in the portion where the terminal fitting is crimped to the electric wire (for example, see Patent Documents 1 to 3).
[Patent Document 1] JP-A-2013-127907
[Patent Document 2] JP-A-2013-218866
[Patent Document 3] JP-A-2013-182861

According to a related art, in a terminal-equipped electric wire, there is a possibility that water enters into a core wire from between a crimp position of the core wire and the crimp position of a covering portion of a terminal fitting and this leads to corrosion of the core wire. For this reason, it is desired to further improve corrosion resistance while reducing costs.

### SUMMARY

One or more embodiments provide a terminal-equipped electric wire excellent in corrosion resistance while reducing costs.

In accordance with one or more embodiments, a terminal-equipped electric wire is characterized by the following (1) to (4):

(1) A terminal-equipped electric wire includes an electric wire in which a core wire made of aluminum or an aluminum alloy is covered with a covering and a terminal fitting made of copper or a copper alloy and crimped to an end portion of the electric wire in which the core wire is exposed. The terminal fitting includes a pair of crimp pieces. End portions of the pair of the crimped portions are crimped in a state where the end portions of the pair of the crimped portions are overlapped with each other, so as to cover a surrounding of the electric wire from a leading end of the core wire to a part of the covering. At least the pair of the crimp pieces have top and bottom surfaces and side surfaces thereof covered with an anti-corrosive plated layer.

(2) The terminal-equipped electric wire according to (1),

wherein the anti-corrosive plated layer is a tin-plated layer.

(3) The terminal-equipped electric wire according to (1) or (2),

wherein the terminal fitting includes a projected portion projecting toward the electric wire in a longitudinal direction of the electric wire and extending in a first position in which the terminal fitting is crimped to the core wire.

(4) The terminal-equipped electric wire according to any one of (1) to (3),

wherein the terminal fitting includes a second projected portion projecting toward the electric wire and extending in a direction orthogonal to the longitudinal direction of the electric wire in a second position in which the terminal fitting is crimped to the core wire, and a third projected portion projecting toward the electric wire and extending in the direction orthogonal to the longitudinal direction of the electric wire in a third position in which the terminal fitting is crimped to the covering.

In the terminal-equipped electric wire of the structure of the above (1), the surrounding from the leading end of the core wire over to a part of the covering is covered with a pair of crimp pieces the end portions of which are laid one on the other. Therefore, the entrance of water into the boundary portion between the core wire and the covering can be suppressed. Moreover, since the top and bottom surfaces and side surfaces of the crimp pieces are covered with the anti-corrosive plated layer, the occurrence of galvanic corrosion between the core wire and the terminal fitting can be suppressed. Therefore, the corrosion resistance of the core wire of the electric wire made of aluminum or an aluminum alloy can be enhanced while costs are reduced, so that the reliability of the connection between the electric wire and the terminal fitting can be enhanced.

In the terminal-equipped electric wire of the structure of the above (2), by forming the tin-plated layer as the anti-corrosive plated layer on the terminal fitting, the occurrence of galvanic corrosion between the core wire and the terminal fitting can be easily suppressed.

In the terminal-equipped electric wire of the structure of the above (3), by the projected portion pressing the core wire in the direction of the length, the strength of crimping of the core wire by the crimp pieces can be enhanced in the direction of the length. Thereby, the entrance of water into the core wire is suppressed, so that corrosion resistance can be further enhanced.

In the terminal-equipped electric wire of the structure of the above (4), by the projected portion digging into the core wire and the covering in the circumferential direction, the strength of crimping with the core wire and the strength of crimping with the covering can be further enhanced. Thereby, the entrance of water into the crimp position of the core wire is suppressed, so that corrosion resistance can be further enhanced.

According to the present invention, a terminal-equipped electric wire excellent in corrosion resistance while costs is reduced.

The present invention has been briefly described above. Further, details of the present invention will be further clarified by reading through the mode for carrying out the invention (hereinafter, referred to as “embodiment”) described below with reference to the attached drawings.

### BRIEF DESCRIPTION OF THE DRAWINGS

FIG. 1 is a perspective view of a terminal-equipped electric wire according to the present embodiment.

FIG. 2 is a cross-sectional view of a terminal fitting of the terminal-equipped electric wire according to the present embodiment.

FIG. 3 is a plan view of a chainlike terminal fitting after stamping.

FIG. 4 is a plan view of the chainlike terminal fitting after plating.

FIG. 5 is a cross-sectional view of a terminal fitting of a terminal-equipped electric wire according to a comparative example.

FIG. 6 is a schematic cross-sectional view of the leading end portion of a core wire of the terminal-equipped electric wire according to the comparative example.

FIG. 7 is a schematic cross-sectional view of the boundary portion between the core wire and a covering of the terminal-equipped electric wire according to the comparative example.

FIG. 8 is a schematic cross-sectional view of the leading end portion of the core wire of the terminal-equipped electric wire according to the present embodiment.

FIG. 9 is a cross-sectional view of the leading end portion of the core wire of the terminal fitting explaining a modification.

FIGS. 10A and 10B are views explaining another modification, FIG. 10A is a cross-sectional view in a direction orthogonal to the axial direction of a conductor crimp portion of the terminal fitting, and FIG. 10B is an A-A cross-sectional view of FIG. 10A.

### DETAILED DESCRIPTION

Exemplary embodiments will be described with reference to the drawings.

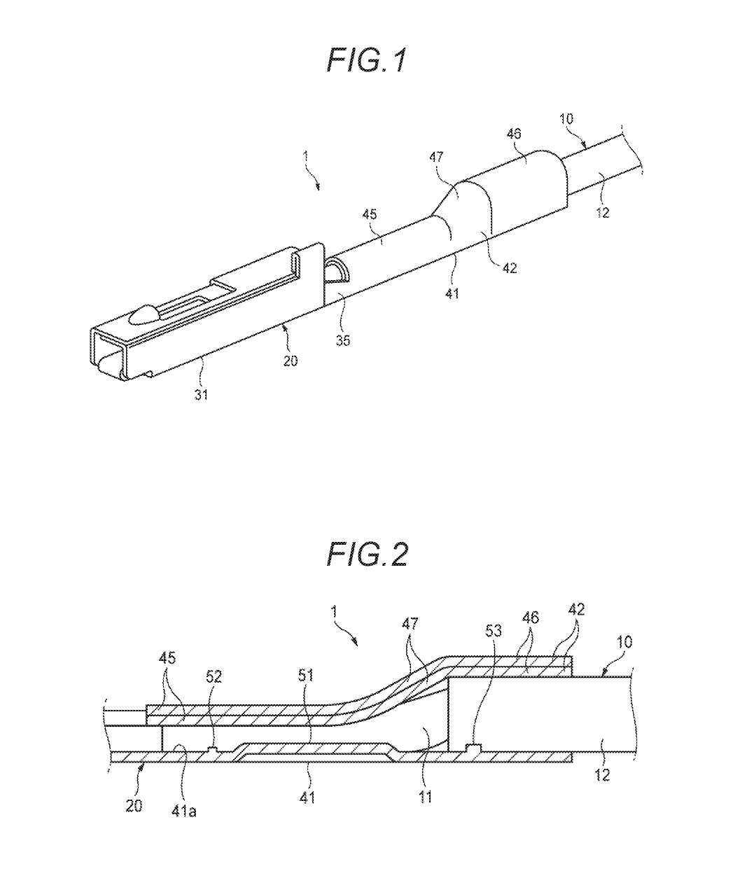

FIG. 1 is a perspective view of a terminal-equipped electric wire according to the present embodiment. FIG. 2 is a cross-sectional view of a terminal fitting of the terminal-equipped electric wire according to the present invention.

As shown in FIGS. 1 and 2, the terminal-equipped electric wire 1 according to the present embodiment is provided with an electric wire 10 and a terminal fitting 20. To an end portion of the electric wire 10, the terminal fitting 20 is crimped to establish electric connection. The terminal-equipped electric wire 1 constitutes, for example, a wire harness routed in a vehicle such as a car.

The electric wire 10 is an insulating electric wire having a core wire 11 and a resin-made covering 12 covering the core wire 11. The core wire 11 is made of aluminum or an aluminum alloy, and is formed by twisting a plurality of strands together. By thus forming the core wire 11 of the electric wire 10 of aluminum or an aluminum alloy, the terminal-equipped electric wire 1 is reduced in weight, so that the wire harness formed of this terminal-equipped electric wire 1 is reduced in weight. The terminal-equipped electric wire 1 with a reduced weight is particularly suitable for use in vehicles such as electric cars and hybrid cars where wire harnesses are heavily used.

The terminal fitting 20 has an electric connection portion 31 in the front and has an electric wire connection portion 41 in the rear. The electric connection portion 31 and the electric wire connection portion 41 are coupled together by a coupling portion 35.

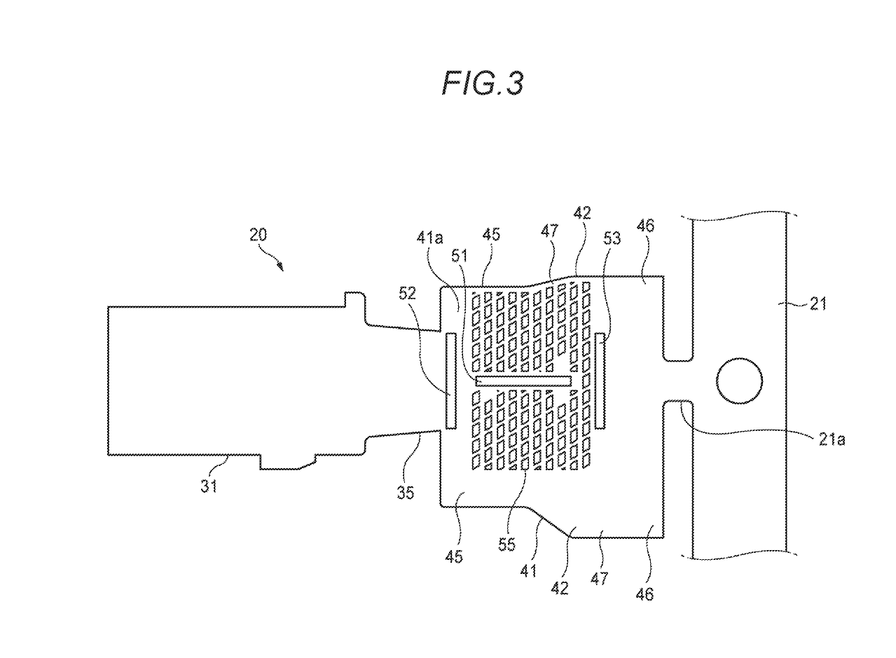

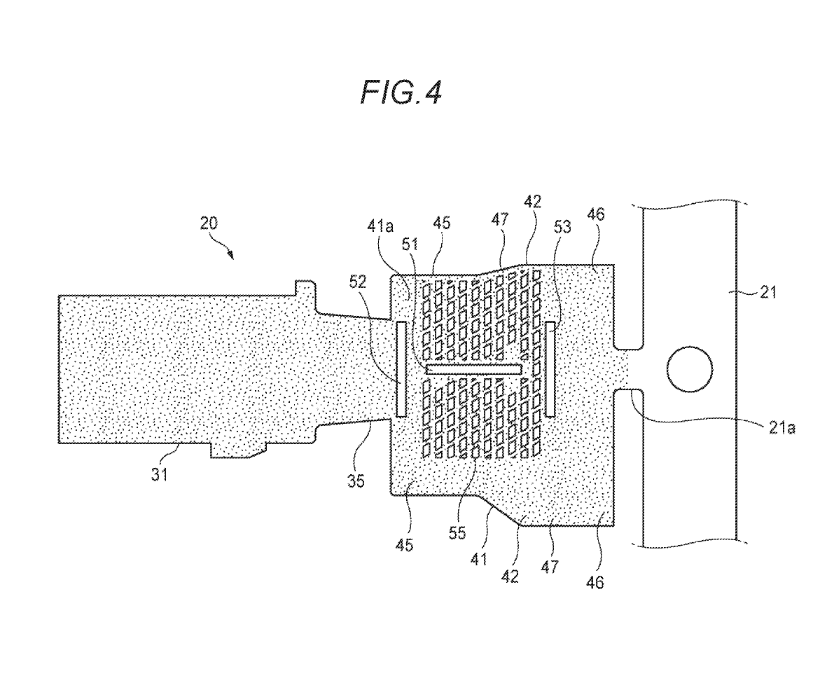

FIG. 3 is a plan view of a chainlike terminal fitting after stamping. FIG. 4 is a plan view of the chainlike terminal fitting after plating.

As shown in FIG. 3, the terminal fitting 20 is formed by performing press working (stamping and bending) on a metal plate. The terminal fitting 20 is made of a metal material different from that of the core wire 11 of the electric wire 10 made of aluminum or an aluminum alloy. Specifically, the terminal fitting 20 is formed by using as the base material a metal plate made of copper, a copper alloy or the like. The terminal fitting 20 is stamped into a state where it is coupled to a beltlike carrier 21 so as to range in a chain form. Then, when crimped to the electric wire 10, it is cut at a portion 21a of coupling with the carrier 21 to be separated from the carrier 21.

After stamped by press working, as shown in FIG. 4, the terminal fitting 20 is plated to prevent corrosion before crimped to the electric wire 10. In the present example, the terminal fitting 20 before crimped to the electric wire 10 is plated with tin (Sn). Thereby, the terminal fitting 20 is provided with a tin-plated layer 50 so as to cover the top and bottom surfaces and the side surfaces formed of cut surfaces formed by press working.

The electric connection portion 31 is formed in a tubular shape that is open at the leading end, and into the open portion of this electric connection portion 31, the counterpart terminal fitting is inserted to establish electric connection.

The electric wire connection portion 41 is electrically connected by being crimped to an end portion of the electric wire 10. The electric wire connection portion 41 has a pair of crimp pieces 42. The front side of each crimp piece 42 is a conductor crimp portion 45, and the rear side thereof is a covering crimp portion 46. The part of each crimp piece 42 between the conductor crimp portion 45 and the covering crimp portion 46 is a connecting portion 47. The upper surface side, which is one surface, of the electric wire connection portion 41 is a mounting surface 41a where the end portion of the electric wire 10 is placed, and the crimp pieces 42 are bent in such a manner as to wrap the end portion of the electric wire 10 with the end portion of the electric wire 10 being placed on the mounting surface 41a. Thereby, the crimp pieces 42 are crimped to the end portion of the electric wire 10 by the end portions thereof being crimped so as to be laid one on the other.

Moreover, the electric wire connection portion 41 has a pressing projected portion 51 (projected portion), a front projected portion 52 (projected portion) and a rear projected portion 53 (projected portion) formed thereon. The pressing projected portion 51 is provided substantially in the center in the direction of the width of the electric wire connection portion 41, and is formed in the direction of the length of the electric wire 10. The front projected portion 52 is provided on the front side of the electric wire connection portion 41, and the rear projected portion 53 is provided on the rear side of the electric wire connection portion 41. The front projected portion 52 and the rear projected portion 53 are both formed in the direction of the width of the electric wire connection portion 41. These pressing projected portion 51, front projected portion 52 and rear projected portion 53 all protrude from the mounting surface 41a where the end portion of the electric wire 10 is placed toward the inside which is the side of the electric wire 10.

Further, on the electric wire connection portion 41, a serration 55 having a plurality of holes is formed on the inner surface which is the mounting surface 41a.

The electric wire connection portion 41 of the terminal fitting 20 is crimped to the end portion of the electric wire 10 by crimping the crimp pieces 42. Specifically, under a condition where the end portion of the electric wire 10 where the core wire 11 is exposed is placed on the mounting surface 41a of the electric wire connection portion 41, the crimp pieces 42 are bent in such a manner as to wrap the end portion of the electric wire 10 and crimped so that the end portions thereof are laid one on the other. By doing this, the conductor crimp portions 45 of the crimp pieces 42 are crimped so as to cover the core wire 11 of the electric wire 10, the covering crimp portions 46 thereof are crimped so as to cover the covering 12 of the electric wire 10, and further, the connecting portions 47 thereof are crimped so as to cover the boundary portion between the core wire 11 and the covering 12 of the electric wire 10. Moreover, the electric wire 10 is brought into a condition where the part on the front side of the leading end of the core wire 11 is covered with the conductor crimp portion 45. This brings the electric wire 10 into a condition where the entire area from the leading end of the core wire 11 over to a part of the covering 12 is covered with the electric wire connection portion 41.

Moreover, when the crimp pieces 42 of the electric wire connection portion 41 are crimped to the end portion of the electric wire 10, by the pressing projected portion 51 pressing the core wire 11 of the electric wire 10 in the direction of the length of the electric wire 10, the strength of crimping of the core wire 11 by the conductor crimp portions 45 of the crimp pieces 42 is enhanced in the direction of the length. Moreover, in a part near the leading end of the core wire 11 of the electric wire 10, by crimping the crimp pieces 42, the front projected portion 52 digs into the core wire 11 in the circumferential direction, so that the crimping strength near the leading end of the core wire 11 is further enhanced. Thereby, the entrance of water into the core wire 11 from the front side of the electric wire connection portion 41 is suppressed. Further, in the part of the covering 12 of the electric wire 10, the rear projected portion 53 digs into the covering 12 in the circumferential direction, so that the crimping strength at the covering 12 is enhanced. Thereby, the entrance of water into the gap between the covering crimp portions 46 and the covering 12 from the rear side of the electric wire connection portion 41 is also suppressed.

Moreover, when the crimp pieces 42 are crimped to the electric wire 10, the serration 55 formed on the mounting surface 41a of the electric wire connection portion 41 digs into the core wire 11. Thereby, the oxide coating on the surface of the core wire 11 is removed, so that excellent conduction state between the electric wire 10 and the terminal fitting 20 is obtained.

Now, a terminal-equipped electric wire according to a comparative example will be described.

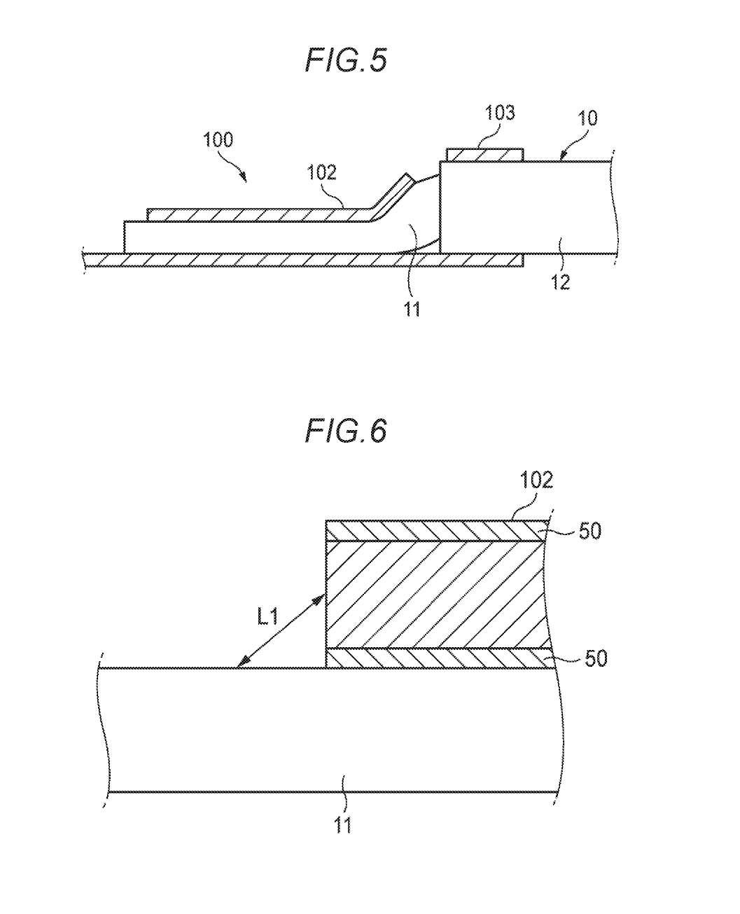

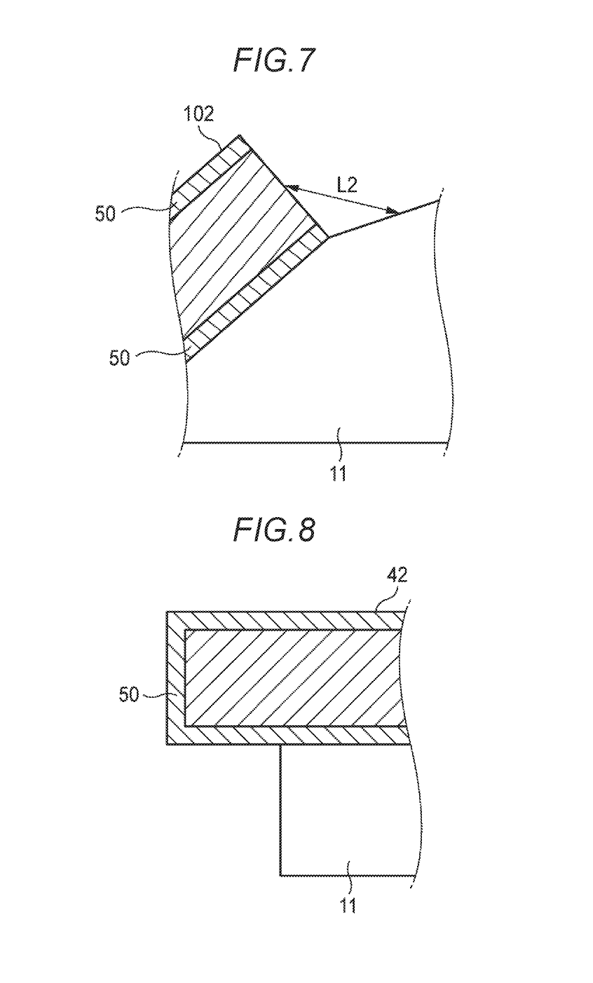

FIG. 5 is a cross-sectional view of a terminal fitting of the terminal-equipped electric wire according to the comparative example. FIG. 6 is a schematic cross-sectional view of the leading end portion of a core wire of the terminal-equipped electric wire according to the comparative example. FIG. 7 is a schematic cross-sectional view of the boundary portion between the core wire and a covering of the terminal-equipped electric wire according to the comparative example. FIG. 8 is a schematic cross-sectional view of the leading end portion of the core wire of the terminal-equipped electric wire according to the present embodiment.

As shown in FIG. 5, the terminal fitting 100 according to the comparative example has a conductor crimp portion 102 crimping the core wire 11 and a covering crimp portion 103 crimping the covering portion, and these conductor crimp portion 102 and covering crimp portion 103 are separated from each other. Moreover, after a metal plate of copper or a copper alloy as the base material is plated with tin (Sn), the terminal fitting 100 is cut and bent by press working, and then, is crimped to the electric wire 10. The electric wire 10 to which the terminal fitting 100 is crimped is exposed at the boundary portion between the core wire 11 and the covering 12, and further, the leading end portion of the core wire 11 is not covered with the conductor crimp portion 102 but is exposed.

In the terminal-equipped electric wire according to the comparative example having the structure as described above, as shown in FIG. 6, a different metals adjoining portion formed of the core wire 11 and the base material with an extremely small creepage distance L1 is formed at the leading end portion of the core wire 11, and as shown in FIG. 7, a different metals adjoining portion formed of the core wire 11 and the base material with an extremely small creepage distance L2 is also formed at the boundary portion between the core wire 11 and the covering 12.

Therefore, in this comparative example, galvanic corrosion can occur by water adhering to the different metals portions of the core wire 11 made of aluminum or an aluminum alloy and the base material of the terminal fitting 100 made of copper or a copper alloy.

On the contrary, in the terminal-equipped electric wire 1 according to the present embodiment, the surrounding from the leading end of the core wire 11 over to a part of the covering 12 is covered with the pair of crimp pieces 42 the end portions of which are laid one on the other. Therefore, the entrance of water into the boundary portion between the core wire 11 and the covering 12 can be suppressed. Moreover, since the top and bottom surfaces and side surfaces of the crimp pieces 42 are covered with the tin-plated layer 50 (anti-corrosive plated layer) as shown in FIG. 8, the occurrence of galvanic corrosion between the core wire 11 and the terminal fitting 20 can be suppressed. Therefore, in the terminal-equipped electric wire 1 according to the present embodiment, the corrosion resistance of the core wire 11 made of aluminum or an aluminum alloy can be enhanced while costs are reduced, so that the reliability of the connection between the electric wire 10 and the terminal fitting 20 can be enhanced.

Moreover, in a position of the terminal fitting 20 where it is crimped to the core wire 11, the pressing projected portion 51 is formed in the direction of the length of the electric wire 10. Therefore, by the pressing projected portion 51 pressing the core wire 11 in the direction of the length, the strength of crimping of the core wire 11 by the crimp pieces 42 can be enhanced in the direction of the length. Thereby, the entrance of water into the core wire 11 is suppressed, so that corrosion resistance can be further enhanced.

Further, in a position of the terminal fitting 20 where it is crimped to the core wire 11 and in a position thereof where it is crimped to the covering 12, the front projected portion 52 and the rear projected portion 53 are formed in the direction of the width which is a direction orthogonal to the direction of the length of the electric wire 10. Therefore, by the front projected portion 52 digging into the core wire 11 in the circumferential direction and the rear projected portion 53 digging into the covering 12 in the circumferential direction, the strength of crimping with the core wire 11 and the strength of crimping with the covering 12 are further enhanced. Thereby, the entrance of water into the crimp position of the core wire 11 is suppressed, so that corrosion resistance can be further enhanced.

The present invention is not limited to the above-described embodiment and modifications, improvements and the like are possible as appropriate. Besides, the materials, shapes, dimensions, numbers, disposition positions and the like of the elements of the above-described embodiment are arbitrary as long as the present invention is attained, and are not limited.

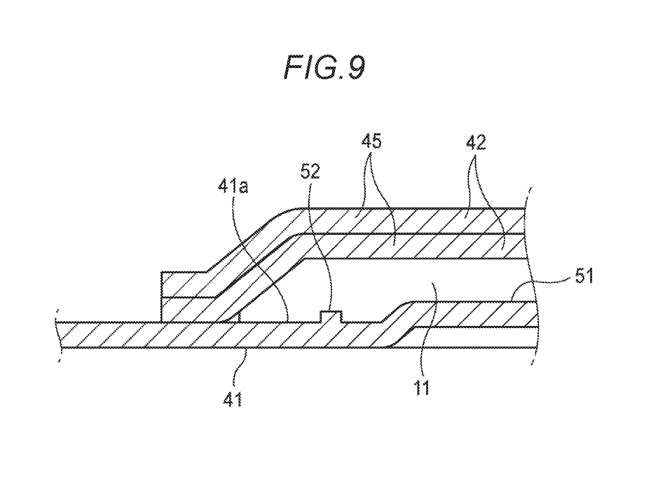

For example, as shown in FIG. 9, the crimp pieces 42 may be crushed so as to eliminate the gap at the leading end of the core wire 11 at the front part of the electric wire connection portion 41. By doing this, the exposure of the leading end of the core wire 11 can be eliminated, so that corrosion resistance can be enhanced.

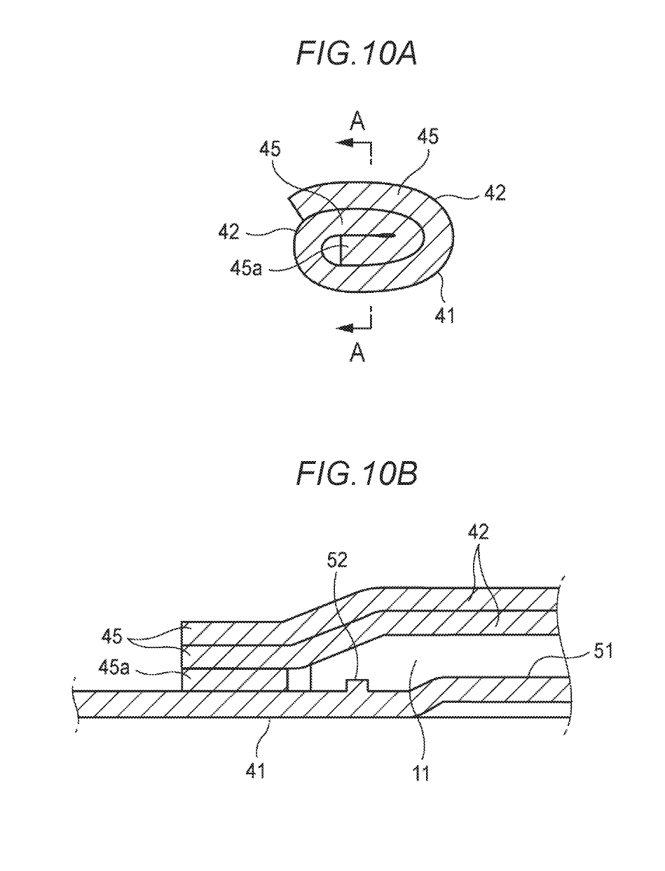

Moreover, as shown in FIGS. 10A and 10B, a blocking piece 45a that enters into the leading end of the core wire 11 when crimped may be formed at the front part of the conductor crimp portion 45 at, of the pair of crimp pieces 42, one crimp piece 42 that is rolled inward. By doing this, the exposure of the leading end of the core wire 11 can be eliminated by blocking the leading end side of the core wire 11 by the blocking piece 45a, so that corrosion resistance can be enhanced.

Now, features of the above-described embodiment of the terminal-equipped electric wire according to the present invention are briefly summarized and listed in the following [1] to [4]:

[1] A terminal-equipped electric wire (1) comprising an electric wire (10) in which a core wire (11) made of aluminum or an aluminum alloy is covered with a covering (12), and a terminal fitting (20) made of copper or a copper alloy and crimped to an end portion of the electric wire (10) in which the core wire (11) is exposed,

wherein the terminal fitting (20) includes a pair of crimp pieces (42),

wherein end portions of the pair of the crimped portions are crimped in a state where the end portions of the pair of the crimped portions are overlapped with each other, so as to cover a surrounding of the electric wire (10) from a leading end of the core wire (11) to a part of the covering, and

wherein at least the pair of the crimp pieces (42) have top surfaces, bottom surfaces and side surfaces which are covered with anti-corrosive plated layers (50).

[2] The terminal-equipped electric wire according to [1],

wherein the anti-corrosive plated layer (50) is a tin-plated layer.

[3] The terminal-equipped electric wire according to [1] or [2],

wherein the terminal fitting (20) includes a first projected portion (the pressing projected portion 51) projecting toward the electric wire (10) in a longitudinal direction of the electric wire (10) in a first position in which the terminal fitting (20) is crimped to the core wire (11).

[4] The terminal-equipped electric wire according to any of [1] to [3],

wherein the terminal fitting (20) includes a second projected portion (the front projected portion 52) projecting toward the electric wire (10) in a direction orthogonal to the longitudinal direction of the electric wire (10) in a second position in which the terminal fitting (20) is crimped to the core wire (11), and a third projected portion (the rear projected portion 53) projecting toward the electric wire (10) in the direction orthogonal to the longitudinal direction of the electric wire (10) in a third position in which the terminal fitting (20) is crimped to the covering (12).

### DESCRIPTION OF REFERENCE NUMERALS AND SIGNS

1: Terminal-equipped electric wire
10: Electric wire
11: Core wire
12: Covering
20: Terminal fitting
42: Crimp piece
50: Tin-plated layer (anti-corrosive plated layer
51: Pressing projected portion (projected portion)
52: Front projected portion (projected portion)
53: Rear projected portion (projected portion)

What is claimed is:

1. A terminal-equipped electric wire comprising:
an electric wire in which a core wire made of aluminum or an aluminum alloy is covered with a covering, and a terminal fitting made of copper or a copper alloy and crimped to an end portion of the electric wire in which the core wire is exposed,
wherein the terminal fitting includes a pair of crimp pieces,
wherein end portions of the pair of the crimped portions are crimped in a state where the end portions of the pair of the crimped portions are overlapped with each other, so as to cover a surrounding of the electric wire from a leading end of the core wire to a part of the covering, and
wherein at least the pair of the crimp pieces have top surfaces, bottom surfaces and side surfaces which are covered with anti-corrosive plated layers.

2. The terminal-equipped electric wire according to claim 1,
wherein the anti-corrosive plated layers are tin-plated layers.

3. The terminal-equipped electric wire according to claim 1,
wherein the terminal fitting includes a first projected portion projecting toward the electric wire and extending in a longitudinal direction of the electric wire in a first position in which the terminal fitting is crimped to the core wire.

4. The terminal-equipped electric wire according to claim 1,
wherein the terminal fitting includes a second projected portion projecting toward the electric wire and extending in a direction orthogonal to the longitudinal direction of the electric wire in a second position in which the terminal fitting is crimped to the core wire, and a third projected portion projecting toward the electric wire in the direction orthogonal to the longitudinal direction of the electric wire and extending in a third position in which the terminal fitting is crimped to the covering.
